(19) United States
(12) Patent Application Publication
(10) Pub. No.: US 2018/0249781 A1
(43) Pub. Date: Sep. 6, 2018

(54) HEADSET MOUNTS

(71) Applicant: OTTO ENGINEERING, INC., Carpentersville, IL (US)

(72) Inventors: Gregory Thomas Zawislak, Roscoe, IL (US); Christopher Ole Yttri, Twin Lakes, WI (US); Alan Edmund Derdzinski, Belvidere, IL (US)

(21) Appl. No.: 15/895,450

(22) Filed: Feb. 13, 2018

Related U.S. Application Data
(60) Provisional application No. 62/458,296, filed on Feb. 13, 2017.
(60) Provisional application No. 62/621,441, filed on Jan. 24, 2018.

(51) Int. Cl. A42B 3/30; H04R 1/10

(52) U.S. Cl. CPC A42B 3/30; H04R 1/1091

(57) ABSTRACT

A headset mount allows a headset to be rapidly connected to a rail system of a helmet and to be readily adjustable by a user upon being mounted to the helmet. The headset mount includes a housing, a wireform, a pivot mount, and a yoke. The housing may be configured to engage with a rail system of the helmet. The wireform has a first end pivotally connected to the housing for rotational movement relative to the rail system about a first axis. The pivot mount is slidably connected to the wireform at a second end of the wireform. The pivot mount is movable along a portion of the wireform, along a second axis. The yoke is connected to the pivot mount for rotation about a third axis and is connectable to the earpiece to permit the earpiece to rotate about a fourth axis.

### CROSS-REFERENCE TO RELATED APPLICATIONS AND INCORPORATION BY REFERENCE

This application claims the benefit of U.S. Provisional Application Ser. No. 62/458,296, which was filed on Feb. 13, 2017 and is entitled “Headset Mounting Systems,” and U.S. Provisional Application Ser. No. 62/621,441, which was filed on Jan. 24, 2018 and is entitled “Headset Mounts.” The entire disclosures of the aforementioned provisional patent applications are hereby incorporated by reference.

### TECHNICAL FIELD

Certain embodiments of the present disclosure relate to mounting systems for communication headsets. More specifically, certain embodiments of the present disclosure relate to mounting systems for communication headsets that allow a headset to be quickly mounted to and interchanged between a variety of user worn components, including helmets and headbands.

### BACKGROUND

Headset mounts can be used to secure electronic communication headsets to a helmet using a rail system carried by the helmet. Examples of helmets that incorporate rail systems include the Ops Core helmet and the Team Wendy helmet, which are both used in a variety of military applications. However, known headset mounts are cumbersome to mount and adjust. In this regard, known headset mounts typically require at least partial disassembly of the mount or are large in physical size and require large spatial areas in order to connect the mount to the helmet rail system. Further once connected to the helmet, the mount must often be disassembled, typically using tools, in order to make positional adjustments (e.g., along the rail system) of the mount relative to the helmet.

Further limitations and disadvantages of conventional headset mounts will become apparent to one of ordinary skill in the art, through comparison of such devices with some aspects of the present disclosure as set forth in the remainder of the present application with reference to the drawings.

### BRIEF SUMMARY

Certain embodiments relate to a headset mount that allows a communication headset to be rapidly connected to and interchanged between a variety of different user worn components, including helmets and/or headbands.

Certain embodiments related to a headset mount that allows a communication headset to be rapidly connected to a rail system of a helmet and to be readily adjustable by a user upon being mounted to the helmet, substantially as shown in and/or described in connection with at least one of the figures.

In some embodiments, a headset mount for securing an earpiece (of a communication headset) to a helmet is provided. The headset mount may include a housing, a wireform, a pivot mount and a yoke. The housing may be configured to engage with a rail system of the helmet. The wireform has a first end pivotally connected to the housing for rotational movement relative to the rail system about a first axis. The pivot mount may be slidably connected to the wireform at a second end of the wireform, distal from the first end of the wireform. The pivot mount may be movable along a portion of the wireform along a second axis. The yoke may be connected to the pivot mount for rotation about a third axis and is connectable to the earpiece to permit the earpiece to rotate about a fourth axis.

In some embodiments, the earpiece may be connected to the yoke using one or more ball and socket connections. According to certain aspects of some embodiments, the earpiece may include a pair of balls that engage into respective sockets carried by the yoke.

In some embodiments, the yoke may be configured to carry a spare battery. According to certain aspects, the yoke may include a battery socket that is configured to receive a spare battery.

According to at certain aspects, embodiments of headset mounts are configured to connect to a variety of different rail systems.

In at least some embodiments, the headset mount is configured to releasably lock into multiple positions on the helmet rail system without the use of tools. In some embodiments, the headset mount may include a dovetail feature that engages with a reciprocal dovetail feature on a helmet rail system. In some embodiments, the headset mount may include a detent mechanism for releasably locking the helmet at a plurality of locations along the rail system. In some embodiments, the headset mount may include a flange configured to slidably engage into a channel in the headset mount.

In some embodiments, the wireform is configured to move the earpiece between an operational position at which the earpiece is lowered and positioned over a user's ear and a released position at which the earpiece is raised away from the user's ear. The wireform may incorporate springs that normally bias the wireform and earpiece to the released position. The wireform and housing may include a locking feature for releasably locking the wireform and earpiece in the operational position.

These and other advantages, aspects and novel features of the present disclosure, as well as details of an illustrated embodiment thereof, will be more fully understood from the following description and drawings.

### BRIEF DESCRIPTION OF THE DRAWINGS

In the drawings, various dimensions may be exaggerated for illustrative clarity. Additionally, like reference numbers are utilized to refer to like elements throughout the present disclosure.

FIG. 1A is a perspective view of an embodiment of a headset mount in accordance with various aspects of the present disclosure.

FIG. 1B is an exploded perspective view of the headset mount of FIG. 1A.

FIG. 2A is a perspective view of a base of the headset mount of FIG. 1A.

FIGS. 2B to 2E are top, front, bottom, and side elevation views, respectively, of the base of FIG. 2A

FIG. 2F is a cross-sectional view along line E-E of FIG. 2C.

FIG. 3A is a perspective view of a swivel of the headset mount of FIG. 1A.

FIGS. 3B to 3D are front, top, and rear elevation views, respectively, of the swivel of FIG. 3A.

FIG. 3E is a cross-sectional view along line E-E of FIG. 3C.

FIG. 4A is a perspective view of a cap of the headset mount of FIG. 1A.

FIGS. 4B to 4D are top, bottom, and side elevation views, respectively, of the cap of FIG. 4A.

FIG. 4E is a cross-sectional view along line E-E of FIG. 4B.

FIG. 5A is a perspective view of a yoke of the headset mount of FIG. 1A.

FIGS. 5B and 5C are front and top elevation views, respectively, of the yoke of FIG. 5A.

FIGS. 5D and 5E are cross-sectional views along lines D-D and E-E, respectively, of FIG. 5C.

FIG. 6A is a perspective view of a pivot of the headset mount of FIG. 1A.

FIGS. 6B and 6C are top and side elevation views, respectively, of the pivot of FIG. 6A.

FIG. 6D is a cross-sectional view along line D-D of FIG. 6B.

FIG. 7A is a perspective view of a wireform of the headset mount of FIG. 1A.

FIGS. 7B to 7D are elevation views of the wireform of FIG. 7A.

FIG. 7E is a perspective view illustrating overmolds that may be employed with the wireform.

FIG. 8A is a perspective view showing the headset mount of FIG. 1A installed on the top rail of an Ops Core helmet.

FIGS. 8B and 8C are perspective views depicting installation of the headset mount of FIG. 1A onto the top rail of an Ops Core helmet.

FIG. 9 is a perspective view showing the headset mount of FIG. 1A installed on the back rail of an Ops Core helmet.

FIG. 10 is a perspective view showing a spare battery pocket of the headset mount of FIG. 1.

FIGS. 11A and 11B are elevation views of the headset mount of FIG. 1A, showing the wireform in a released (raised) position (see FIG. 11A) and an operational (lowered) position (See FIG. 11B).

FIGS. 11C and 11D are perspective views illustrating movement of the headset mount from its operational (lowered) position (FIG. 11C) to its released (raised) positon (FIG. 11D).

FIG. 12 is a perspective view of an exemplary headset for use with the headset mount of FIG. 1A.

FIGS. 13A to 13D are perspective views illustrating the headset of FIG. 12 connected to an over-the-head headband according to certain aspects of an embodiment of the present disclosure.

FIGS. 14A and 14B are perspective views illustrating the headset of FIG. 12 connected to behind-the-head headband according to certain aspects of an embodiment of the present disclosure.

FIGS. 15A to 15C are perspective views illustrating installation of the headset of FIG. 12 into the headset mount of FIG. 1.

FIG. 16A is a perspective view of another embodiment of a headset mount in accordance with various aspects of the present disclosure.

FIG. 16B is an exploded perspective view of the headset mount of FIG. 16A.

FIG. 16C is a cross-sectional view along line C-C of FIG. 16B.

FIG. 17A is a perspective view showing the headset mount of FIG. 16A installed on the top rail of a Team Wendy helmet.

FIGS. 17B to 17E are perspective views depicting installation of the headset mount of FIG. 17A onto the top rail of a Team Wendy helmet.

FIGS. 18A and 18B are perspective views showing the headset mount in its operation (lowered) position and its released (raised) position.

FIG. 19 is a perspective view showing the headset mount of FIG. 17A installed on the back rail of a Team Wendy helmet.

FIG. 20A is a perspective view of a base of the headset mount of FIG. 16A.

FIGS. 20B, 20C, 20D and 20F are elevational views of the base shown in FIG. 20A, while FIG. 20E is a cross-sectional view along line E-E of FIG. 20C.

FIG. 21A is a perspective view of another embodiment of a headset mount in accordance with various aspects of the present disclosure.

FIG. 21B is an exploded perspective view of the headset mount of FIG. 21A.

FIGS. 22A-22D depict a wireform of the headset mount of FIG. 21A.

### DETAILED DESCRIPTION

The following detailed description of certain embodiments of the present disclosure will be better understood when read in conjunction with the appended drawings. It should be understood that the various embodiments are not limited to the arrangements and instrumentality shown in the drawings. As used herein, an element or step recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

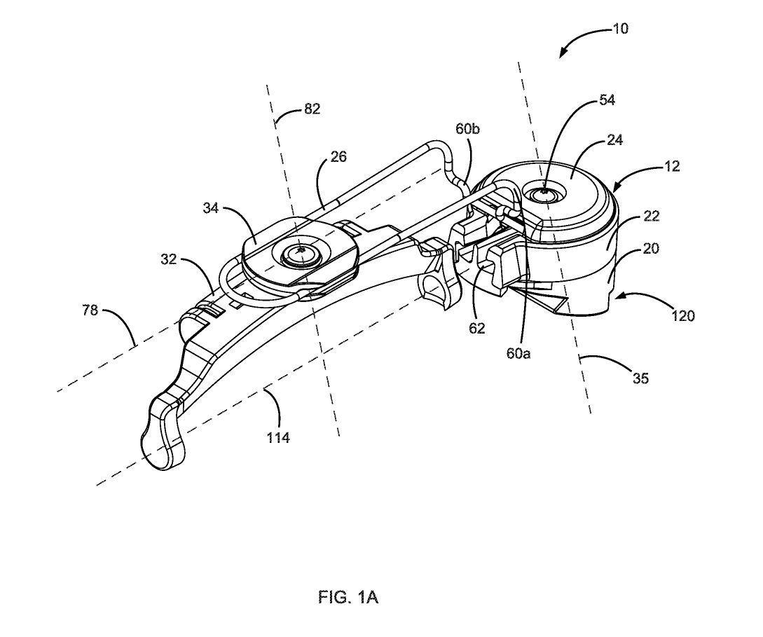

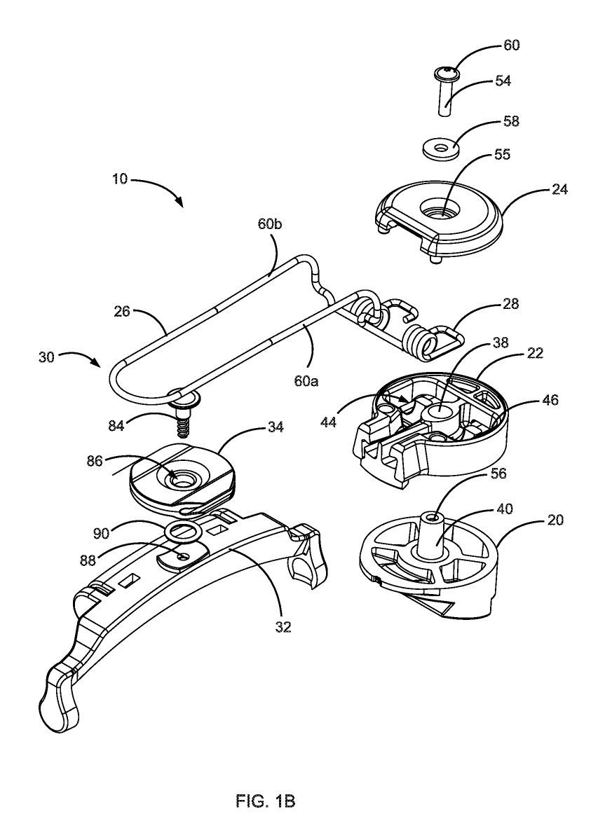

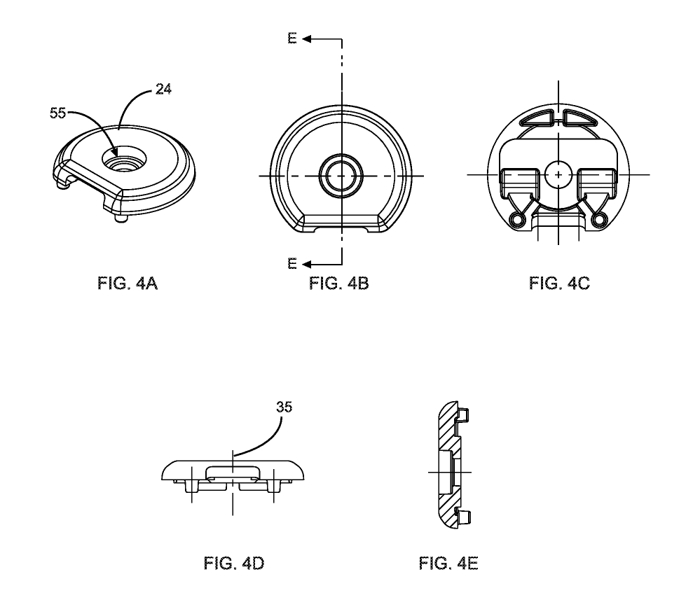

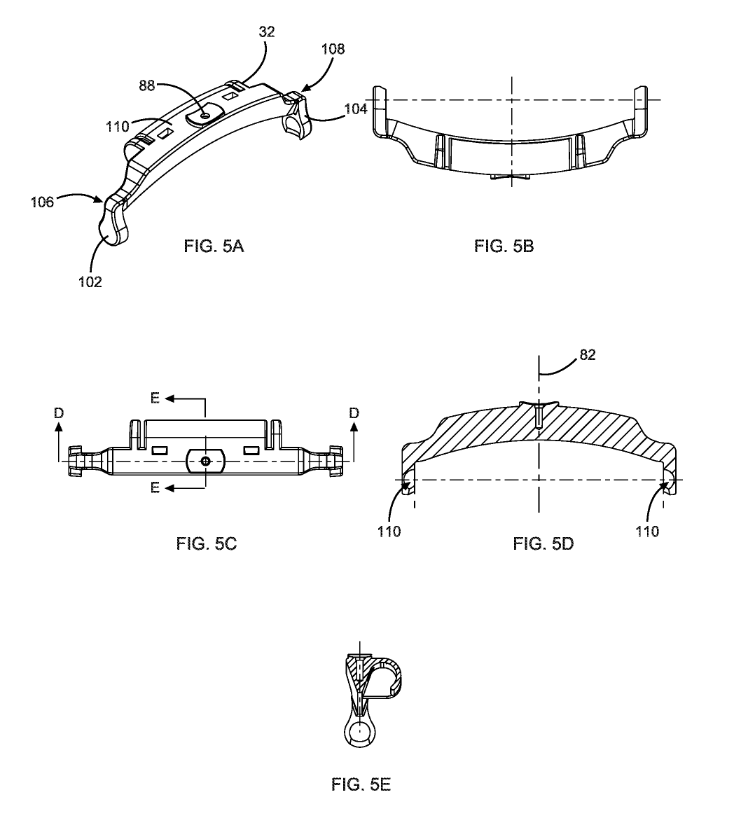

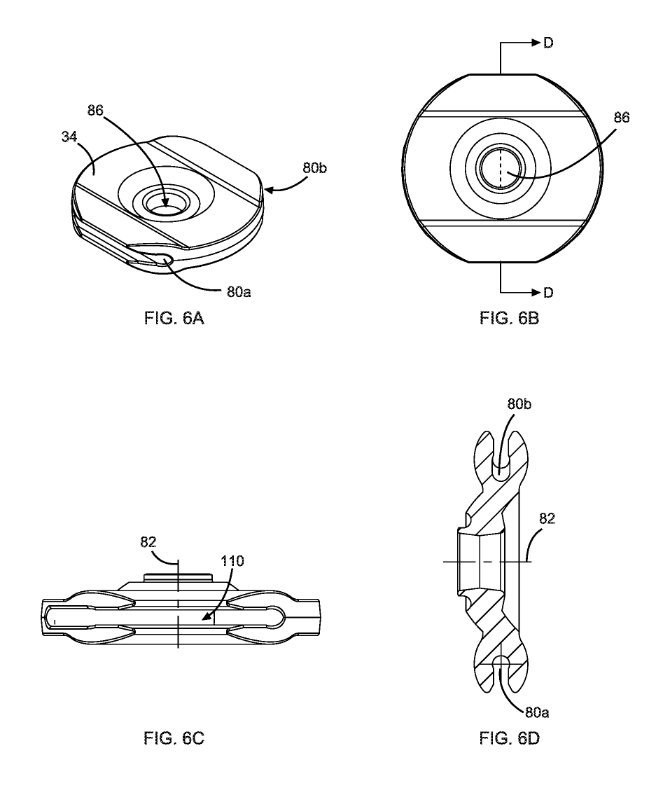

An exemplary embodiment of a headset mount 10 in accordance with various aspects of the present disclosure is illustrated in FIGS. 1A to 7E. The headset mount 10 may generally include a housing 12 consisting of a base 20, a swivel 22, and a cap 24. The headset mount 10 also includes a wireform 26 having a first end 28 secured to the housing 12 and a second end 30 secured to a yoke 32 by a pivot mount 34. In some embodiments, the base 20, swivel 22, cap 24, yoke 32, and pivot mount 34 may all be molded, e.g., injection molded or otherwise, from suitable materials. For example, in some embodiments, the base 20 may be from a medium viscosity delrin resin. In some embodiments, the swivel 22 may be formed from a glass filled nylon resin, for example. In some embodiments, the cap 24 may, for example, be formed from an ABS/polycarbonate resin. In some embodiments, the yoke 32 and/or the pivot mount 24 may be formed from an unfilled nylon resin, for example. In some embodiments, the wireform 26 may, for example, be constructed from relatively stiff material, such as 01.8 mm spring steel with a zinc coating.

In the illustrated embodiment, the housing 12 has a generally cylindrical shape, and the base 20, the swivel 22, and the cap 24 are generally circular when viewed from the top. It will be appreciated, however, that the housing 12 may be any suitable shape.

The swivel 22 is rotatably connected to the base 20 for rotation about a first axis 35. In the illustrated embodiment, an aperture 38 formed in the swivel 22 engages around a boss 40 that extends from the top side 42 of the base 20. In the illustrated embodiment, the aperture 38 in the swivel 22 is defined by a boss 41 that extends from the top side of the swivel 22. The interface between the aperture 38 and the boss 40 allows the swivel 22 to rotate relative to base 20 about the first axis 35, which extends longitudinally along the center of the bosses 40, 41. In the illustrated embodiment, the base 20 is generally circular-shaped and the boss 40 is positioned at the center of the base 20. Accordingly, the first axis 35 extends through the center of the base 20. In certain embodiments, the swivel 22 may rotate at least 360 degrees relative to the base 20 about the first axis 35. In other embodiments, it may be desirable to restrict rotation to less than 360 degrees, in which case features, e.g., stops, may be formed in the base 20 and/or the swivel 22 to limit the range of rotation of these components relative to one another.

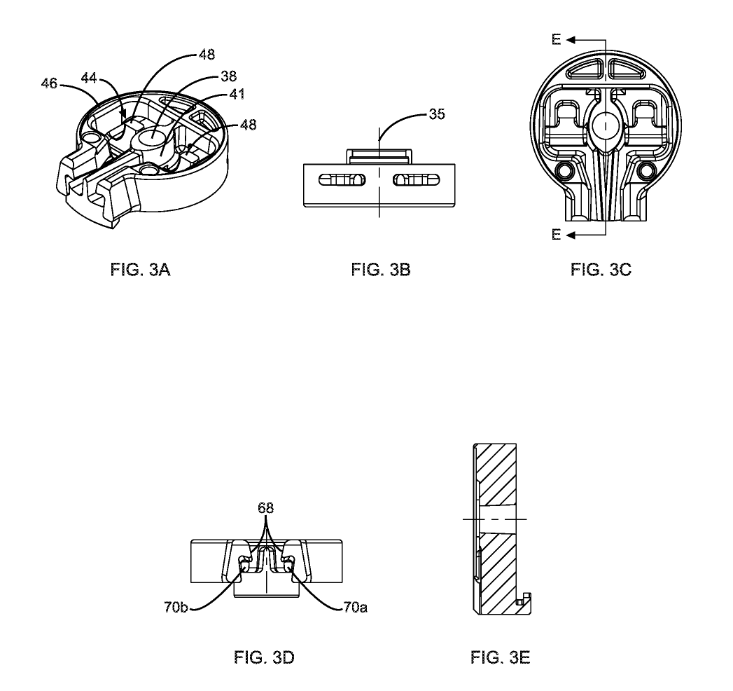

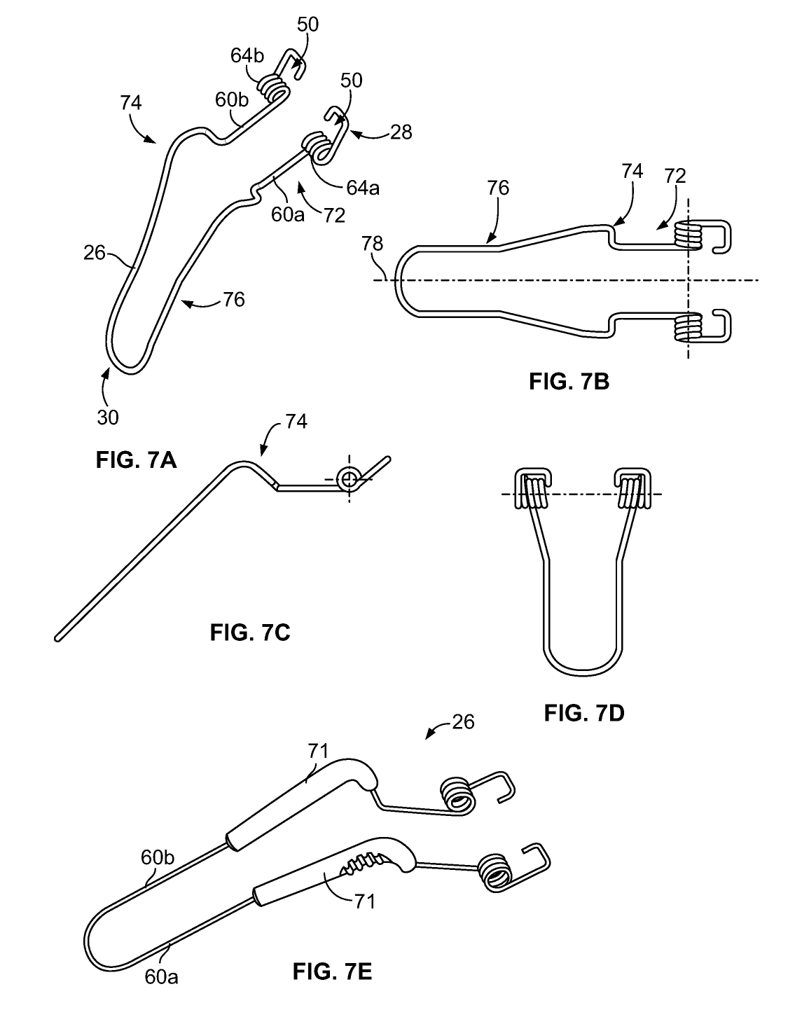

The first end 28 of the wireform 26 is secured to the swivel 22 for rotation therewith relative to the base 20 (about the first axis 35). In the illustrated embodiment, the first end 28 of wireform 26 nests into a compartment 44 formed on the top side of the swivel 22. In the illustrated embodiment, the compartment 44 is defined by a wall 46 that extends upwardly along the outer edge of the swivel 22. The first end 28 of the wireform 26 may include features which interface with features on the swivel 22 to fix the position of the wireform 26 with respect to the swivel 22. For example, in the illustrated embodiment, the interior of the compartment 44 includes flanges 48 (see, e.g., FIG. 3A) that extend through apertures 50 (see, e.g., FIG. 7A) defined in the first end 28 of the wireform 26.

After the first end 28 of the wireform 26 is inserted into the compartment 44 and positioned over the flanges 48, the cap 24 is mounted over the top of the wall 46 to secure wireform 26 in place and to close off the top of the compartment 44. A fastener 54 extends through an aperture 55 in the cap 24, through the aperture 38 in the swivel 22, and into an aperture 56 in the base 20. In the illustrated embodiment, the fastener extends longitudinally along the first axis 35. The fastener 54 may include threads (not shown) that mate with reciprocal threads (not shown) in the base 20 to secure the cap 24 to the base 20. A washer 58 may be positioned around the fastener 54, between a head 60 of the fastener 54 and the cap 24. It will be appreciated that other methods, such as snap-fit connections, adhesives, or sonic welding, may be used to secure the housing components to one another.

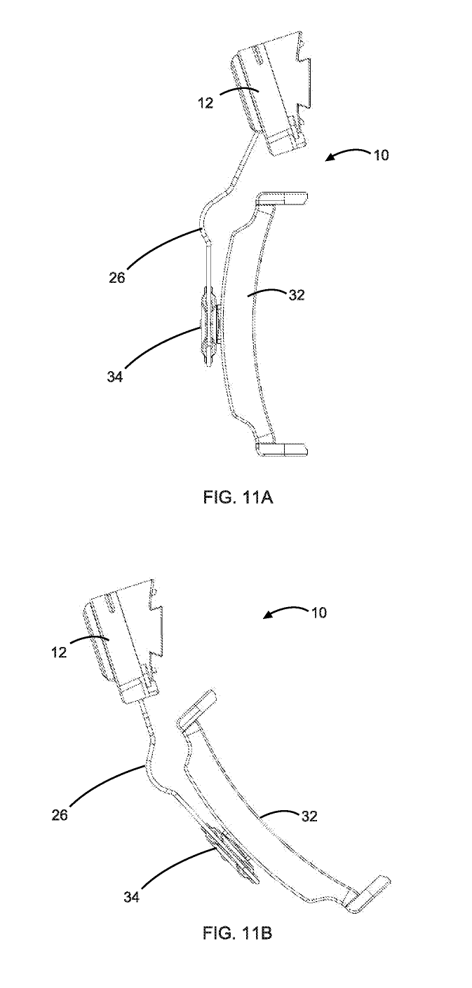

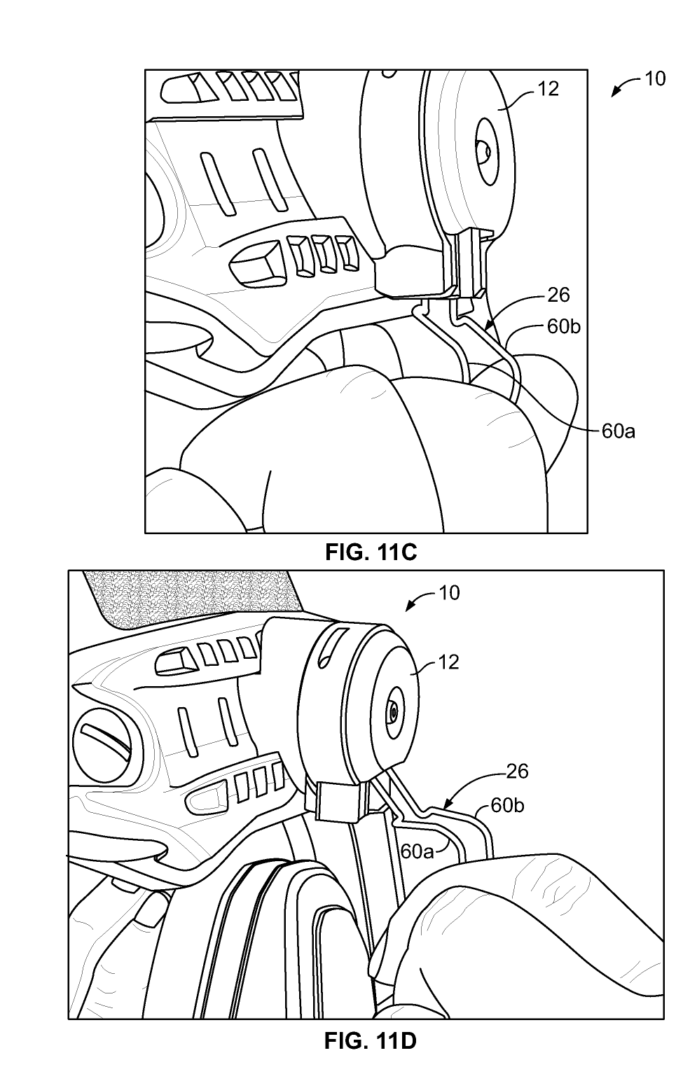

The wireform 26 includes a pair of legs 60a, 60b that generally extend between its first and second ends 28, 30. The legs 60a, 60b, which are generally parallel to one another, extend from the first end 28 and out through an aperture 62 formed in the housing 12. In the illustrated embodiment, the aperture 62 is defined at least in part by an opening formed in the wall 46 of the swivel 22. The legs 60a, 60b are movable within the aperture 62 (and relative to the housing 12) between first or released (raised) position (see FIG. 11A) and a second or operational (lowered) position (see, e.g., FIG. 11B). Springs 64a, 64b, formed at or near the first end 28 of the wireform 26 normally bias the legs 60a, 60b towards their first or released (raised) position. The legs 60a, 60b may be moved from their first (released/raised) position to their second (operational/lowered) position by asserting force against the legs towards (e.g., downward) the second (lowered) position. The side walls 68 of the aperture 62 may be tapered (as illustrated) so that, as the legs 60a, 60b are moved towards the second (operational/lowered) position, the legs are moved inwardly (e.g., towards one another) by the tapered side walls 68. Slots 70a, 70b are positioned at the lower end of the aperture 62, below the tapered side walls 68, for receiving the legs 60a, 60b. When the legs 60a, 60b move past the lower ends of the tapered side walls 68, they spring outwardly and into the slots 70a, 70b, thereby releasably locking the legs at the second (operational/lowered) position. The wireform 26 may be moved from its second (operational/lowered position) to its second (relased/raised position) by squeezing the legs 60a, 60c inwardly towards one another to unseat them from the slots 70a, 70b, as shown in FIG. 11C. Once the legs 60a, 60c are unseated from the slots 70a, 70b, the force from the springs 64a, 64b moves the legs 60a, 60c upwardly to their second (released/raised) position, as shown in FIG. 11D.

As shown in FIG. 7E, the wireform 26 may include overmolds 71 formed of a rubber or other suitable material. The overmolds 71 provide better grip and comfort to the user during manipulation of the legs, e.g., when squeezing the legs 60a, 60b together to facilitate movement from the operational/lowered position to the released/raised position.

As noted above, the yoke 32 is connected to the second end of the wireform 26 by the pivot mount 34. In the illustrated embodiment, the wireform 26 includes a first portion 72 that generally extends from the springs 64a, 64b (at or near the first end 28) to a curved or bent portion 74, and a second portion 76 that generally extends from the curved portion 74 to the second end 30. The pivot mount 34 is slidably connected to the legs 60a, 60b for movement along the wireform's second portion 76 along a second axis 78. In some embodiments, the second axis 78 may extend generally parallel to the legs 60a, 60b in the wireform's second portion 76. In some embodiments, the second axis 78 may be generally perpendicular to the first axis.

In some embodiments, the pivot mount 34 includes grooves 80a, 80b that engage around the legs to allow the pivot mount 34 to slide along the legs 60a, 60b. The pivot mount 34 is attached to the wireform by first inserting (e.g., snapping) one of the legs (e.g., leg 60a) into one of the grooves (e.g., 80a). The legs 60a, 60b are then biased away from one another and the pivot mount 34 is rotated about the leg 60a until the other leg (e.g., 60b) aligns with the other grove (e.g., 80b), at which time the other leg 60b may be inserted (snapped) into the other groove (80b).

The yoke 32 is connected to the pivot mount 34 for movement therewith along the second portion of the wireform 26. In the illustrated embodiment, the yoke 32 is connected to the pivot mount 34 for rotation about a third axis 82 that extends generally perpendicular to the second axis 78. In at least some embodiments, the third axis 82 may be generally parallel to the first axis 35. In the illustrated embodiment, a fastener 84 extends through an aperture 86 in the pivot mount 34 and into an aperture 88 in the yoke 32. The fastener 84 may include threads (not shown) that engage with reciprocal threads in the aperture 88 to secure the yoke 32 to the pivot mount 34. An O-ring 90 or washer may be positioned around the fastener 84 between the yoke 32 and the pivot mount 34.

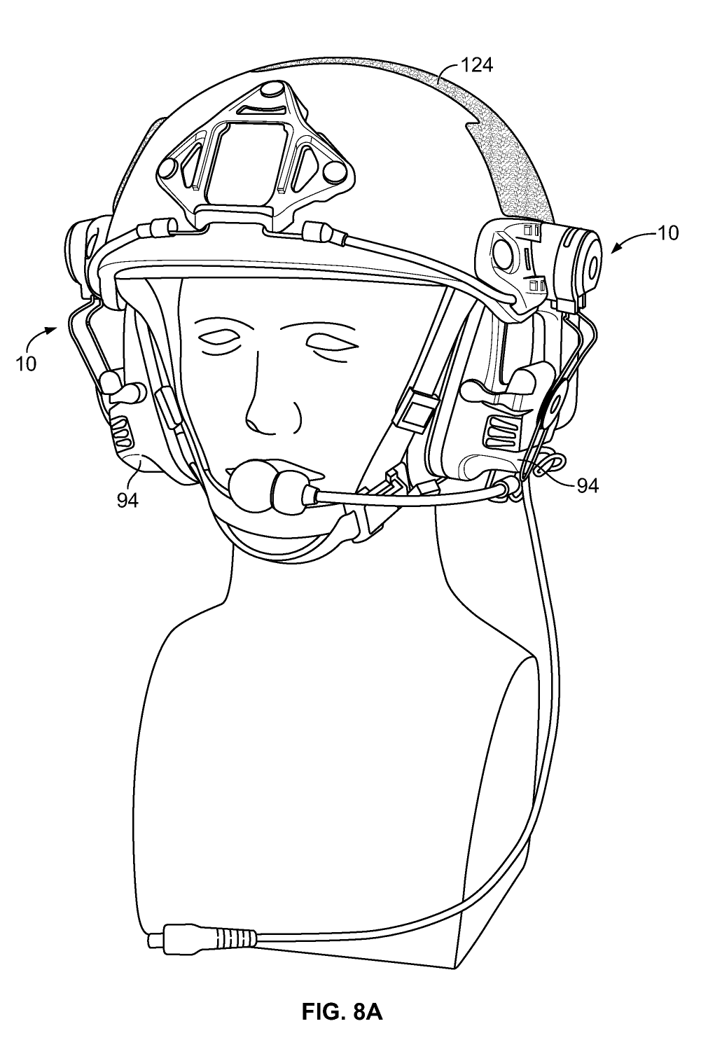

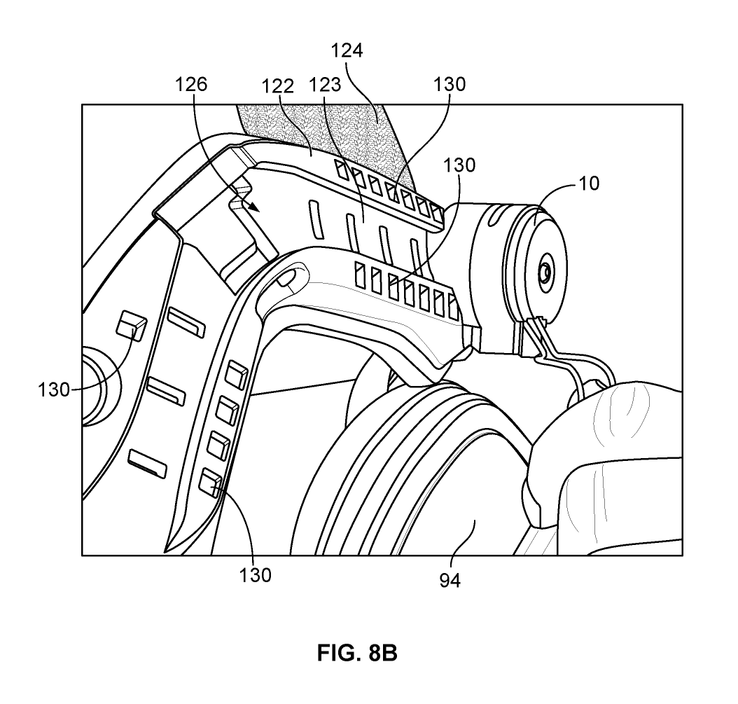

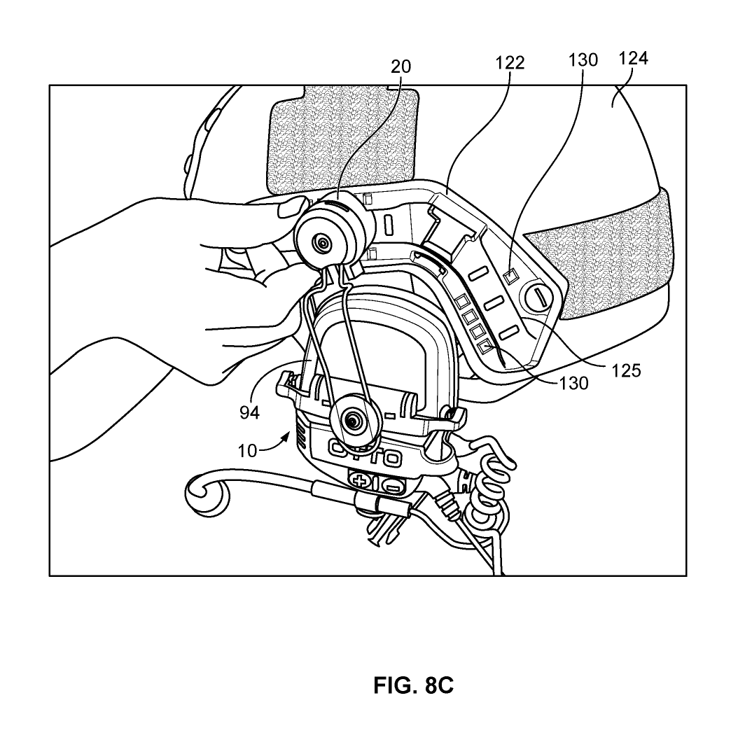

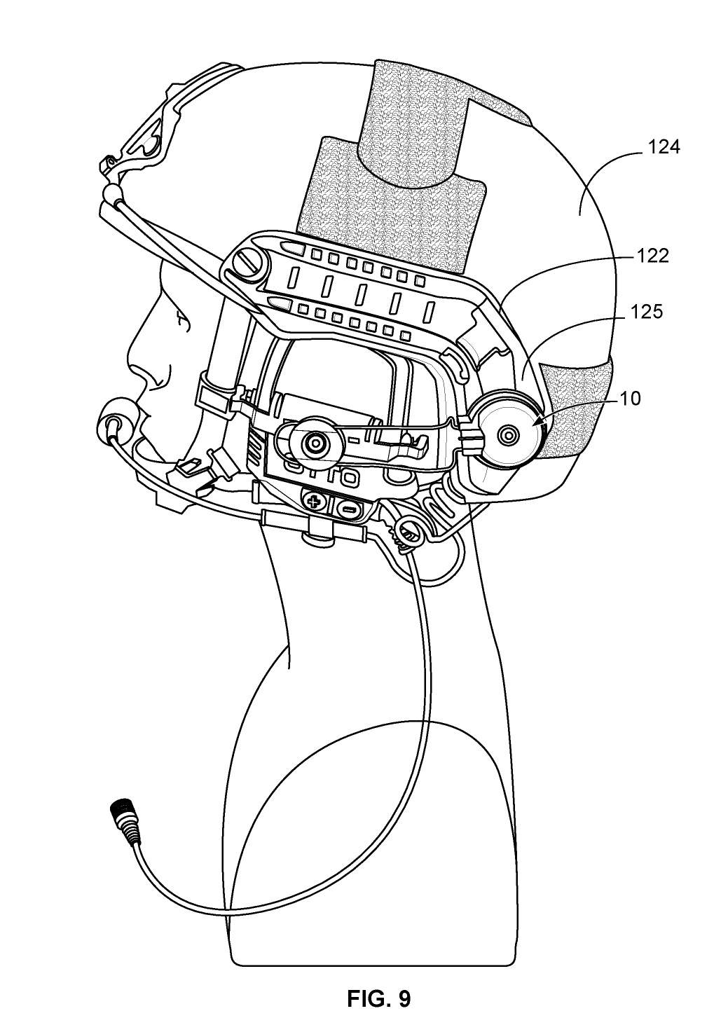

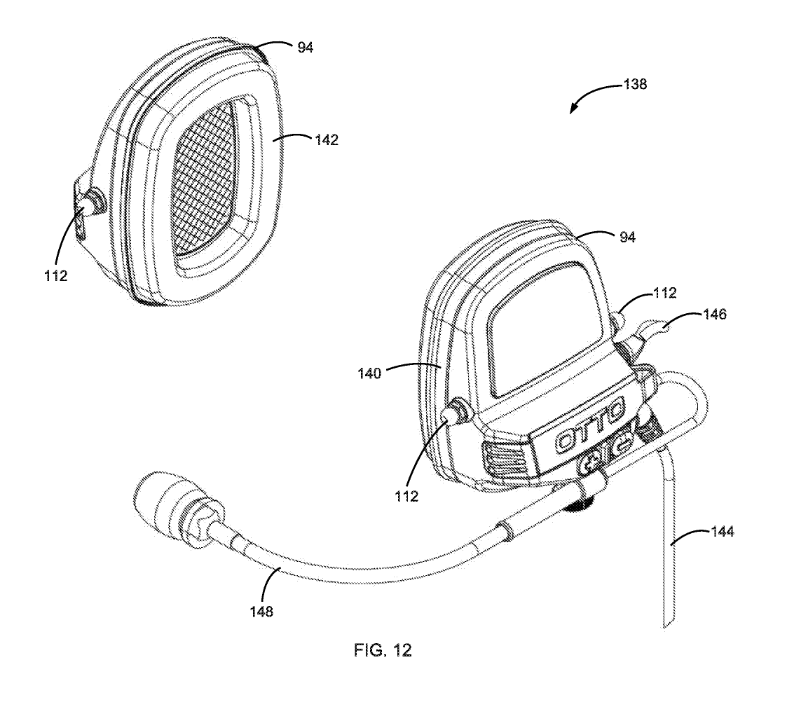

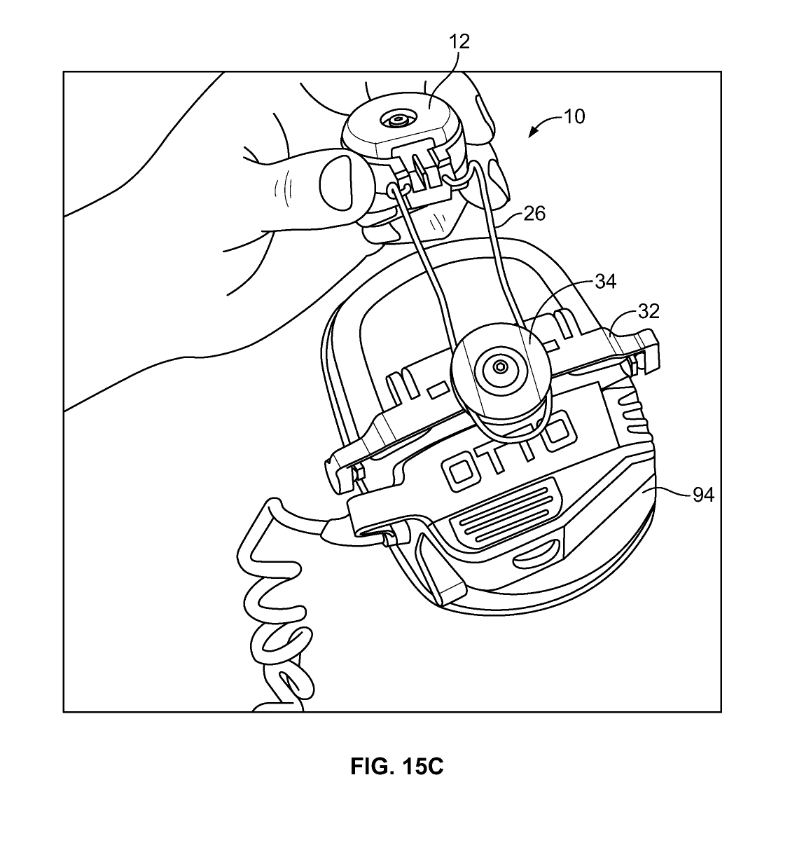

The yoke 32 is configured to secure an earpiece 94 (or earmuffs) (see, e.g., FIGS. 8A and 15A to 15C) of a headset 138 to the wireform 26 of the headset mount 10. In the illustrated embodiment, the yoke 32 includes a generally elongate portion 100 and first and second legs 102, 104 that extend from first and second ends 106, 108, respectively, of the elongate portion 100. The legs 102, 104 include features that engage with reciprocal features on the earpiece 94 to allow the earpiece to be secured to the yoke 32. In the illustrate embodiment, the legs 102, 104 present sockets 110. The earpiece 94 in turn includes balls (or pins) 112 (see, e.g., FIG. 12) that engage into the sockets 110 to secure the earpiece 94 to the yoke 32. The balls 112 are solidly fastened to the earpiece 94 and the sockets 110 in the yoke 32 snap over the balls 112 to secure the earpiece 94 to the yoke 32, as illustrated in FIGS. 15A and 15B. The ball-and-socket interface allows the earpiece 94 to pivot (or rotate) relative to the yoke 32 about a fourth axis 114. In some embodiments, the fourth axis 114 may extend generally perpendicular to the first axis 35 and/or the third axis 82. In some embodiments, the configuration of the yoke 32 may be varied from that shown in the drawings to allow the yoke to interface with different earpiece assemblies, such as current branded earpiece assemblies.

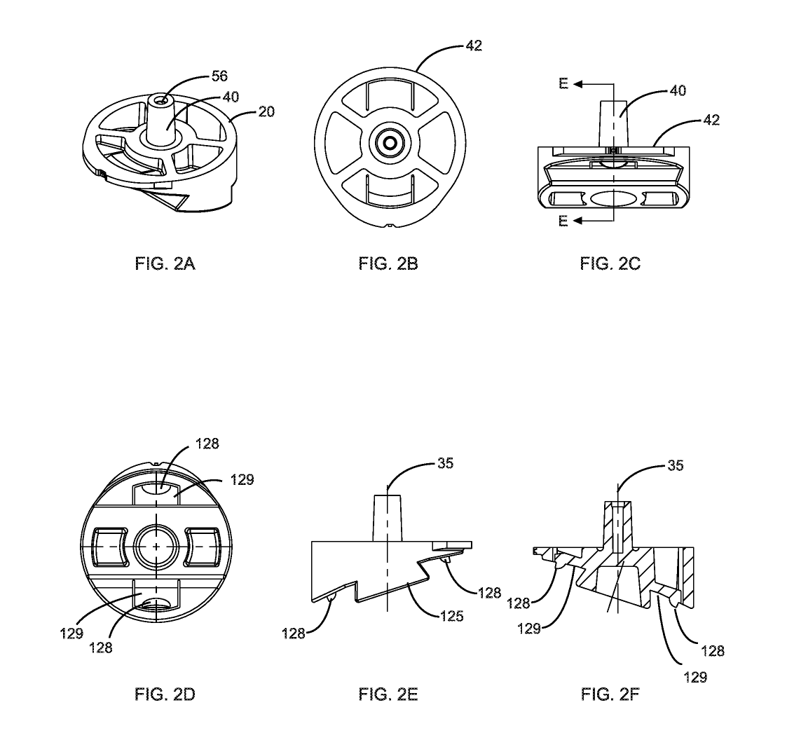

In some embodiments, the headset mount 10 may be configured to mount to the rail system of a helmet, such as the rail systems on the Ops Core and/or Team Wendy helmets. With further reference to FIGS. 8A to 9, the headset mount 10 depicted in FIGS. 1 to 7E is configured for mounting to the rail system 122 of an Ops-Core helmet 124. FIG. 8A shows the headset mount 10 installed on a top rail 123 of the rail system 122, while FIG. 9 shows the headset mount 10 installed on the back rail 125 of the rail system 122. In some embodiments, the base 20 includes an interface 120 that engages with the rail system 122 of the helmet 124 to secure the headset mount 10 to the helmet 124. In some embodiments, the interface 120 between the base 20 and the rail system 122may be in the form of a dovetail joint, where the base includes a profile or cross-section 125 (see, e.g., FIG. 2E) that slides into a channel 126 in the rail system, e.g., from an end of the channel. In at least some embodiments, the interface may include a detent mechanism configured to releasably lock the base 20 at predefined locations along the rail system 122. In certain embodiments, the detent mechanism includes protrusions 128 (see, e.g., FIGS. 2D-2F) formed on the base 20 that engage into sockets 130 (see, e.g., FIGS. 8B and 8C) formed on the rail system 122. The headset mount 10 may be adjusted along the length of the rail system 122 by applying force, e.g., forward or backward, to disengage the detent mechanism and allow the base 20 to move between detent positions. In at least some embodiments, the protrusions 128 may be carried by flexible hinges 129 formed on the base 20 that allow the protrusions 128 to flex inwardly (into the base 20) to facilitate movement between the sockets 130 of the rail system 122. Upon reaching one of the sockets 130 on the rail system 122, the hinges 129 bias the protrusions outwardly and into the sockets 130, thereby releasably fixing the position of the base 20 on the rail system 120. By applying force (e.g., forward or backward), the base 20 can be moved longitudinally along the rail system 122 and between the detent positions.

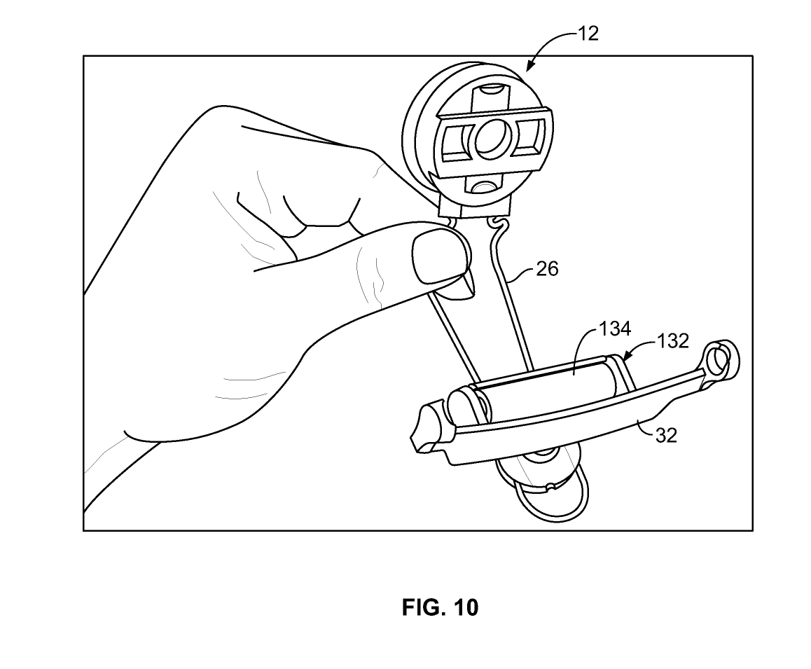

As illustrated in FIG. 10, in some embodiments the yoke 32 may be configured to carry at least one spare battery for the earpiece 94. In certain embodiments, the yoke 32 may include a socket 132 that is configured to carry a spare battery 134. The battery 134 may be removed from the socket 132 by tapping the yoke 32 on the palm of one's hand to dislodge the battery from the socket.

FIG. 12 is a perspective view of exemplary headset 138 for use with the headset mount 10 of FIG. 1A. In the illustrated embodiment, the headset 138 includes a pair of earpieces 94. In the illustrated embodiment, the earpieces 94 include a primary earpiece 140 and a secondary earpiece 142. A cable 144 may interconnect the headset 138 with a communication device (not shown) such as a two-way radio or other suitable device. In the illustrated embodiment, the cable 144 is interconnected with the primary earpiece 140, which is, in turn, interconnected with the secondary earpiece 142 by a second cable 146. The earpieces 140, 142 can be removably connected to the cables 144, 146 by suitable connects, e.g., cable jacks and ports (not shown). In the illustrated embodiment, the primary earpiece 140 includes a microphone, in the form of a boom microphone 148. Both ear pieces 140, 142 include internally mounted speakers (not shown).

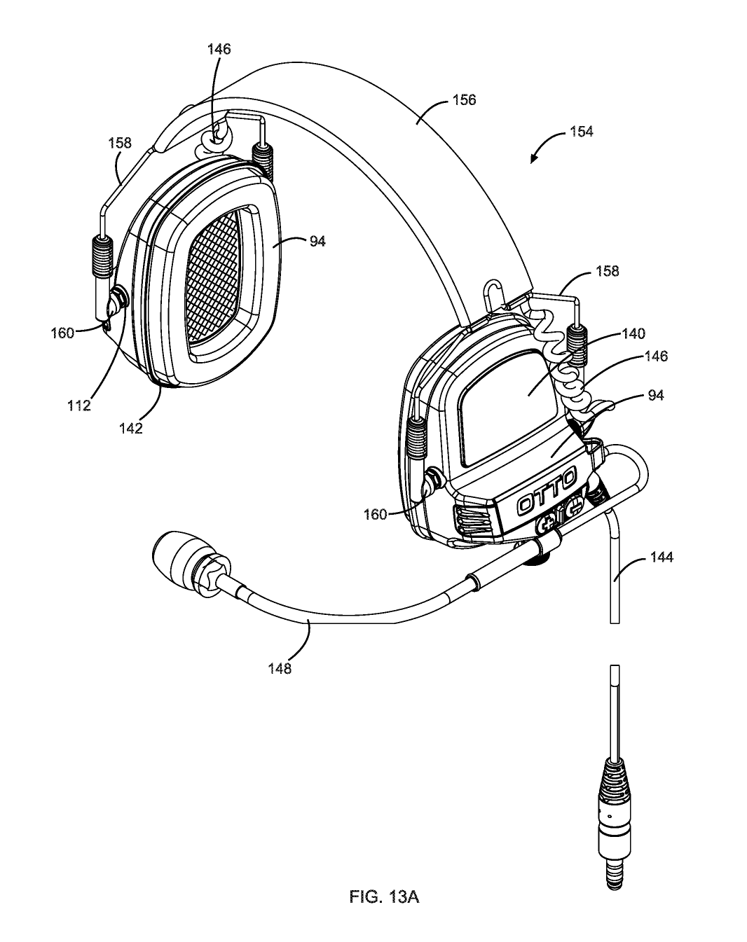

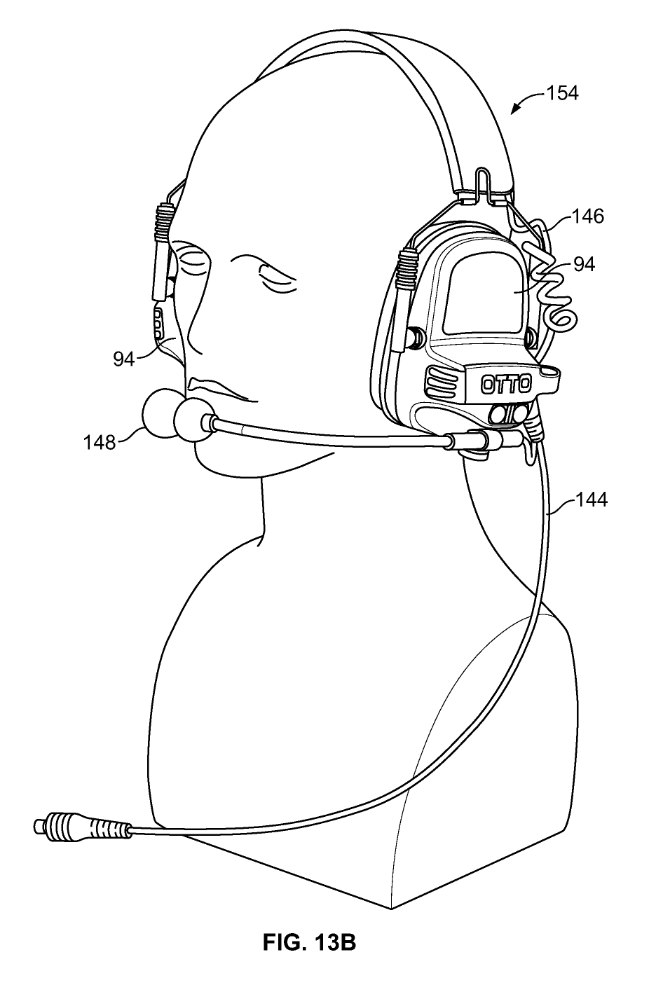

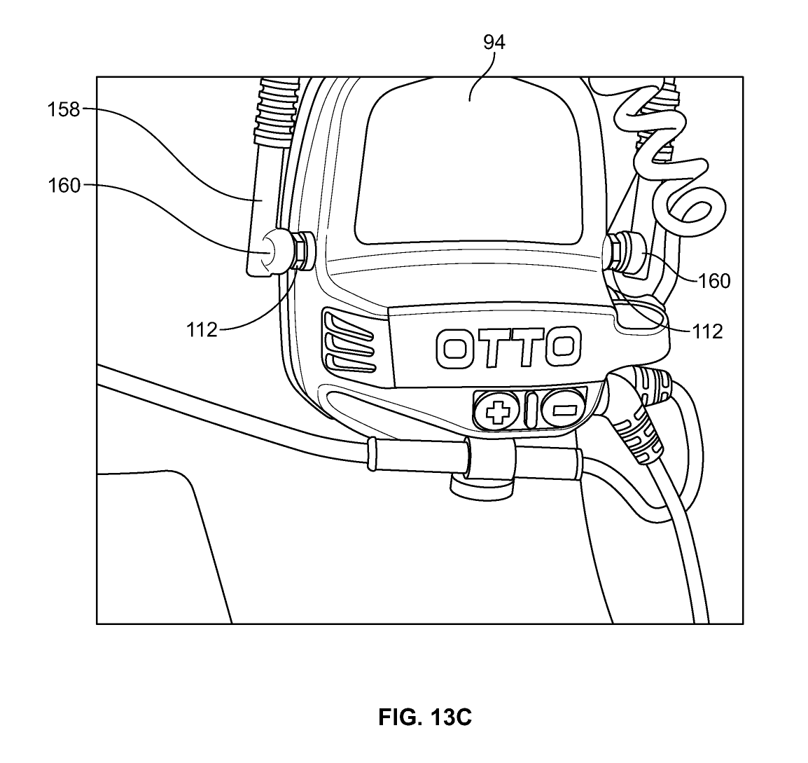

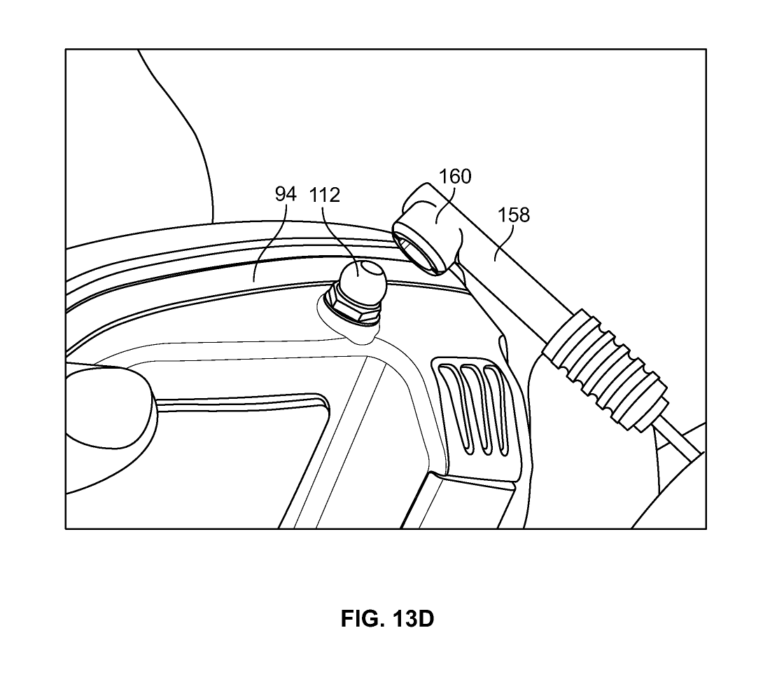

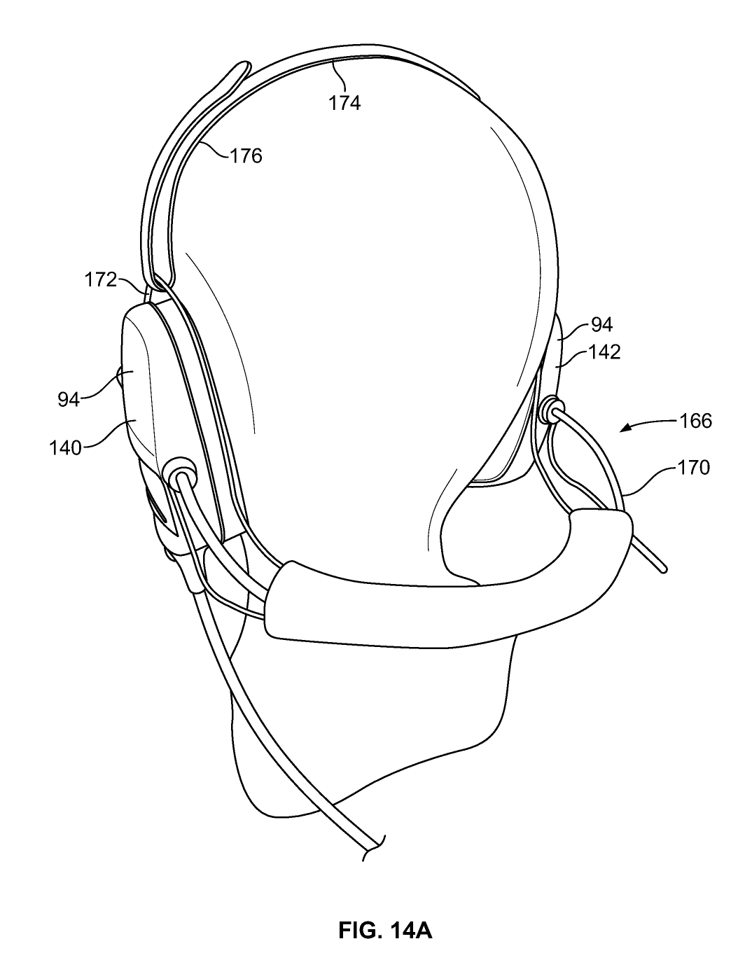

FIGS. 13A-13D are views depicting the headset 138 of FIG. 12 connected to an over-the-head headband 154 according to certain aspects of an embodiment of the present disclosure. The headband 154 includes a flexible band 156 configured to extend over a user's head, and pair of yokes 158 connected to opposite ends of the flexible band 156. As can best be seen in FIGS. 13C and 13D, the yokes 158 include sockets 160 that mate with the balls 112 of the earpieces 94 to allow the earpieces to be secured to the headband 154 in the manner discussed above.

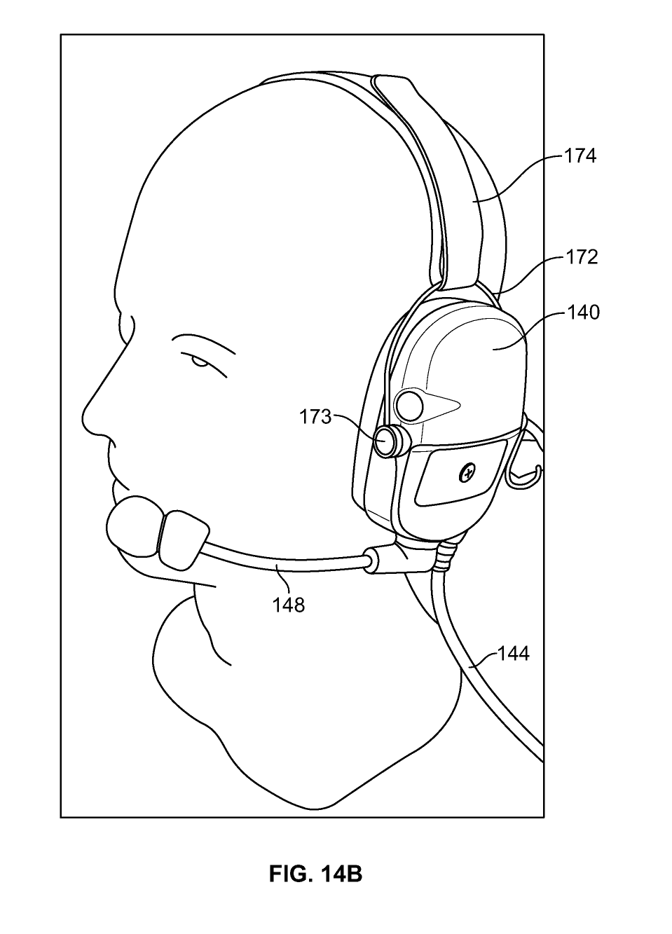

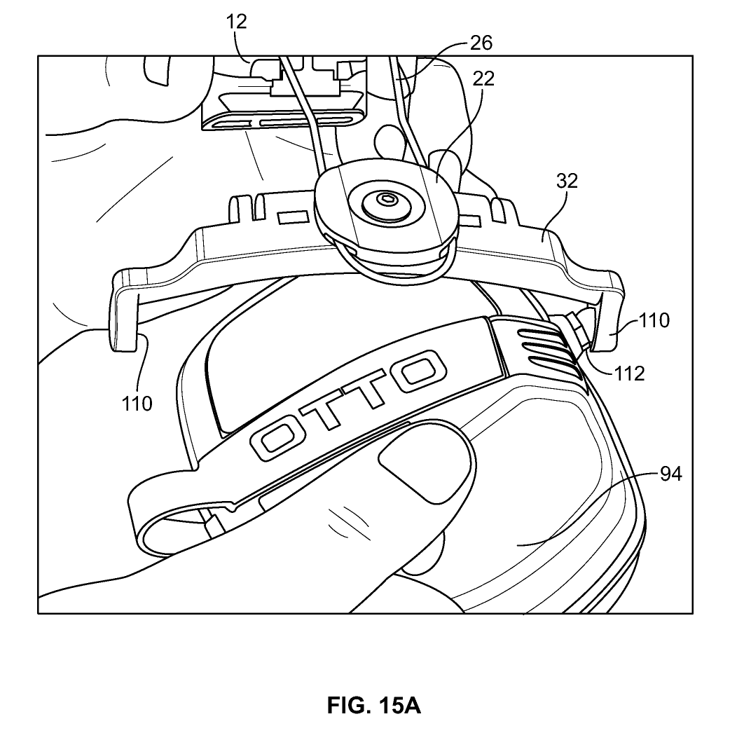

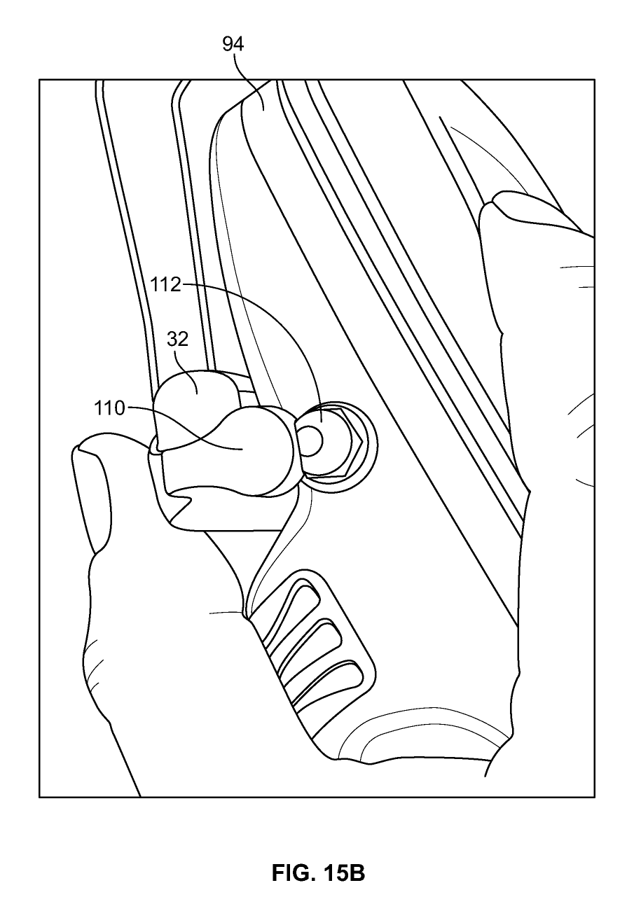

FIGS. 14A and 14B are perspective views illustrating the headset 138 of FIG. 12 connected to behind-the-head headband 166 according to certain aspects of an embodiment of the present disclosure. The headband 166 includes a wireform 170 configured to extend around the back of a user's head. The wireform 170 includes a pair of yokes 172 formed at its ends and positioned to be proximate the user's ears during use. The yokes 172 include sockets 173 configured to mate with the balls 112 to allow the earpieces 94 to be removably connected to the yokes 172 in the manner discussed above. A strap 174 made of a suitable material extends between the yokes and is configured to extend over the top of the users head. The strap 174 may include an adjustment mechanism 176, such as Velcro connectors to allow sizing adjustments.

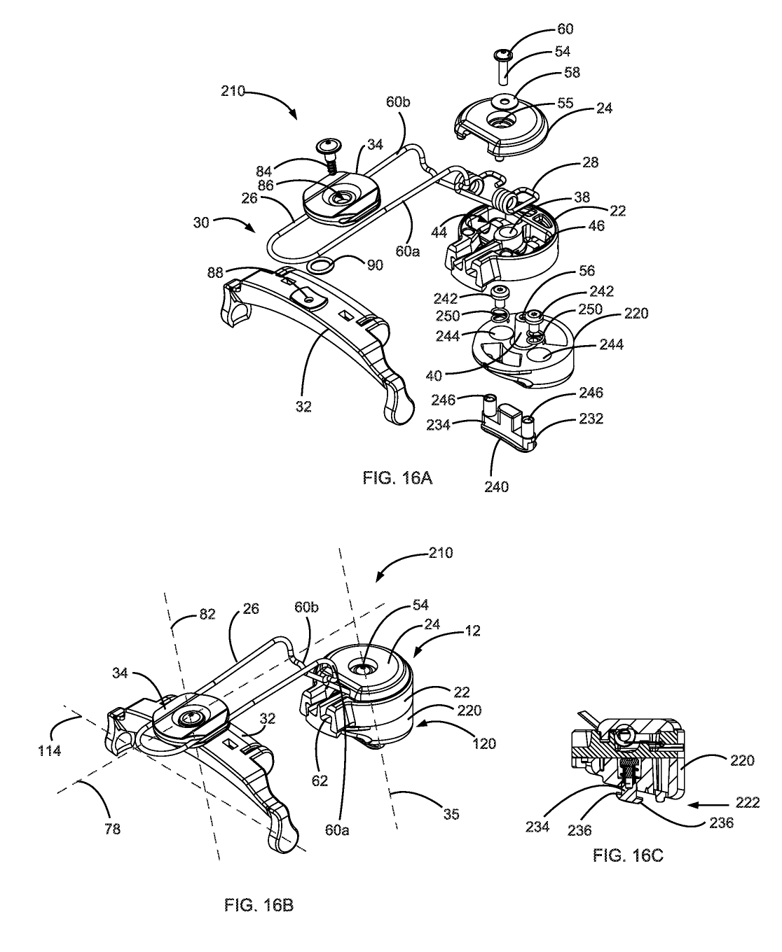

Referring now to FIGS. 16A to 18B, an embodiment of a headset mount 210 that is configured for use with the Team Wendy helmet 214 is described. The headset mount 210 includes many of the same components as the headset mount 10 that was described above. Accordingly, the same element numbers have been used to reference like components in the headset mounts 10, 210. The primary difference between the headset mounts 10 and 210 resides in the mounting interface between the base and the rail system of the respective helmets 124, 214. As described above, the mounting interface that is used with the Ops Core helmet 124 includes a dovetail joint (where a profile 125 on base 20 slides into a channel 126 in the rail system 122) and detent mechanism (where protrusions 128 on the base 20 that engage into sockets 130 on the rail system 122).

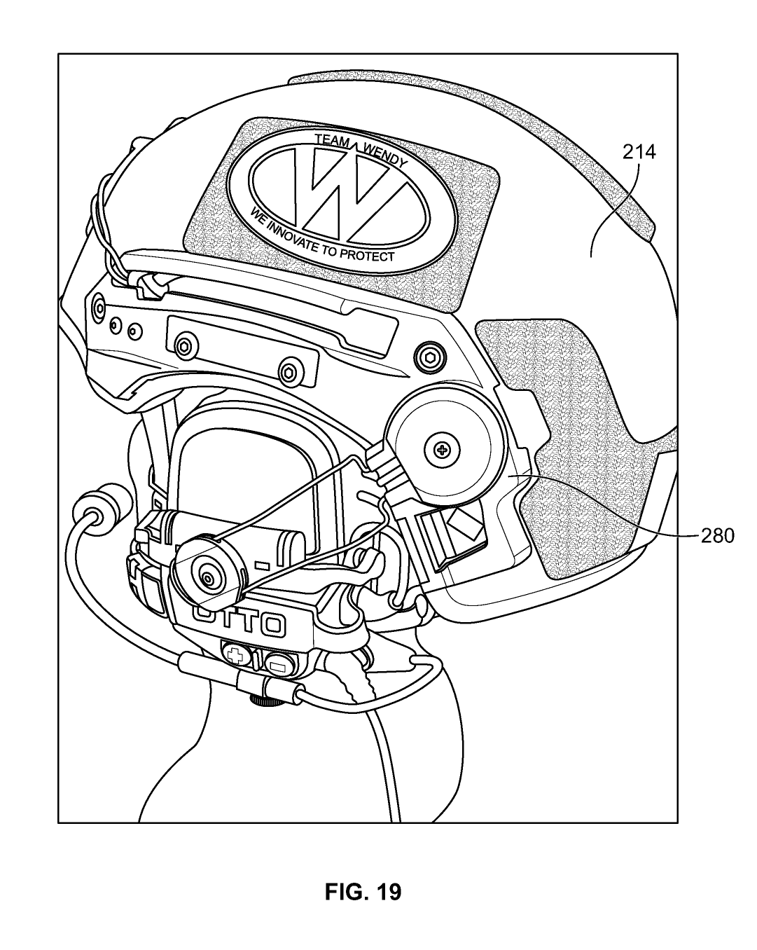

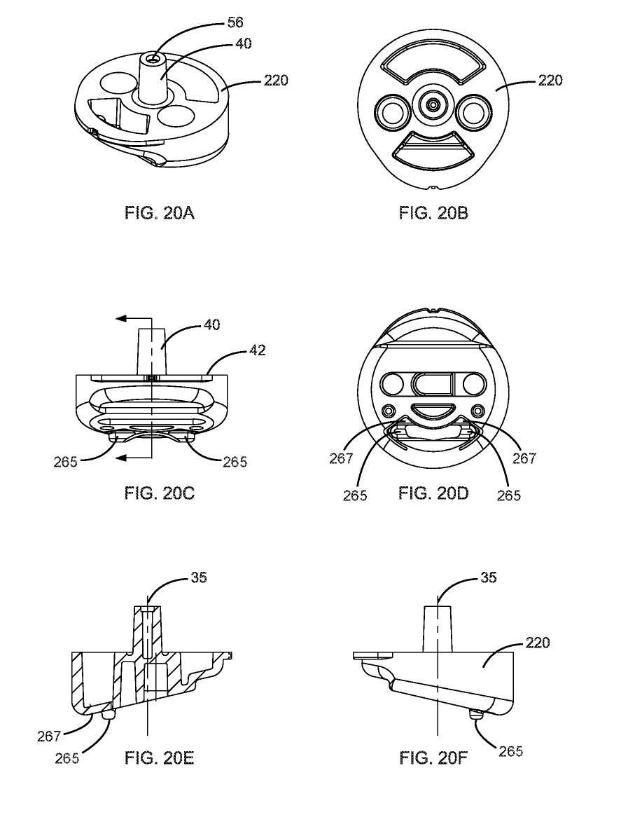

The base 220 of the headset mount 210 includes a mounting interface 222 (see, e.g., FIG. 16C) that may be configured to secure the headset mount 210 to the rail system 230 of the Team Wendy helmet 214. The mounting interface 222 may include a T-shaped bracket 232 that extends from base 220 and is configured to mate with the rail system 230 of the helmet 214. The T-shaped bracket 232 includes a main member 234 that extends outwardly from the base 220 and a pair of cross members 236 that extend laterally from the distal end of the main member 234. In at least some embodiments, the inner faces of the cross members 236 may be arced or curved such that their middle portions 240 are closer to the base 220 than their ends. The proximal end of the main member 234 is secured to the base 220 by a pair of threaded fasteners 242. Each fastener 242 extends through a respective opening 244 in the base 220 and threads into a reciprocal threaded opening 246 in the proximal end of the main member 234. The mounting interface 222 also includes a pair of springs 250 that normally bias the T-shaped bracket 232 inwardly towards the base 220. Each spring 250 is positioned around a respective one of the fasteners 242, between a head of the fastener 242 and the base 220. As explained below, the T-shaped bracket 232 may be moved outwardly from the base 220 (against the force of the springs 250) to engage the T-shaped bracket with the rail system 230 of the helmet 214. In some embodiments, the T-shaped bracket may be formed from a zinc alloy, such as Zamak #5, for example. Further details of the base 220 are illustrated in FIGS. 20A to 20F.

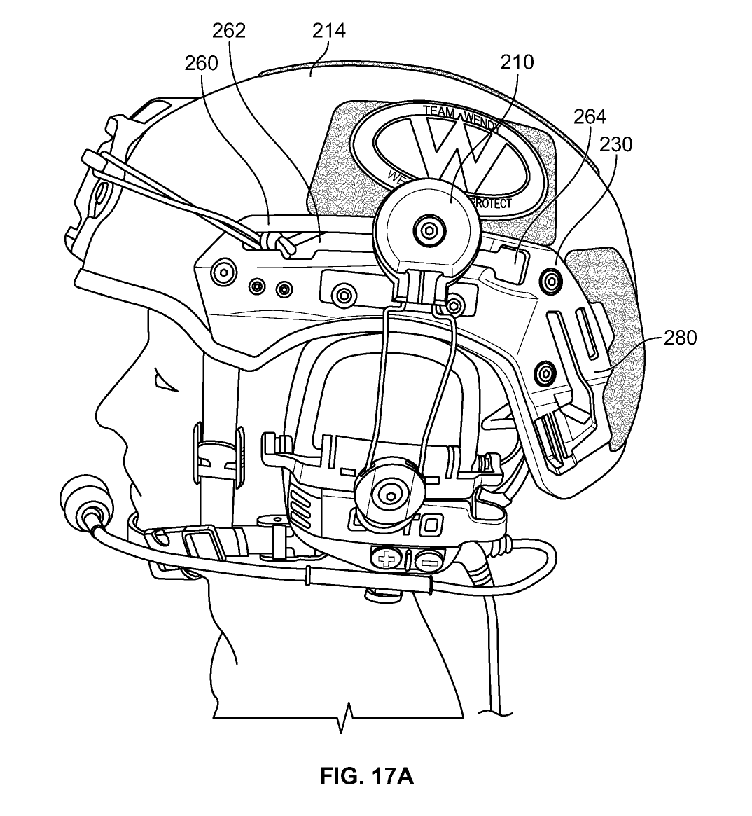

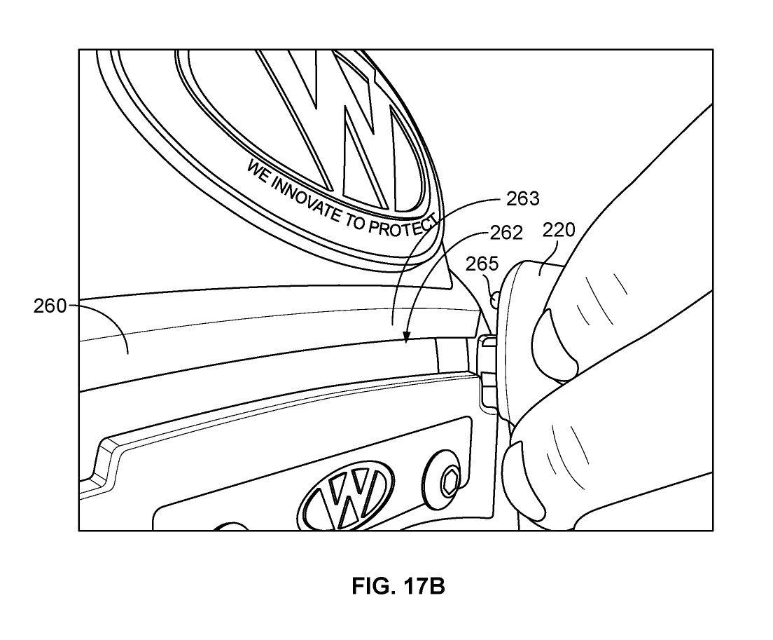

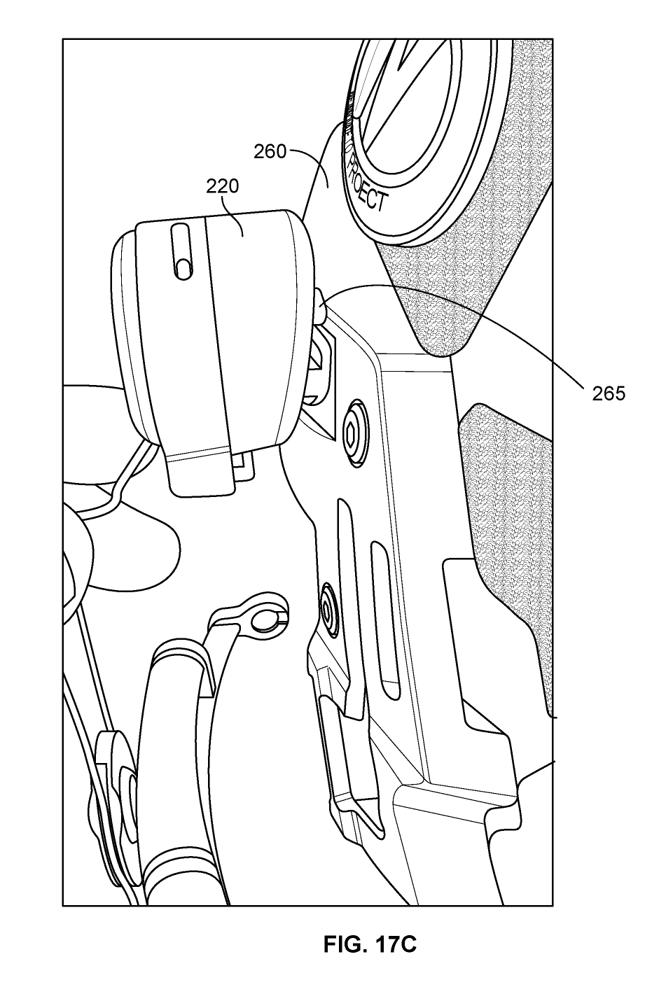

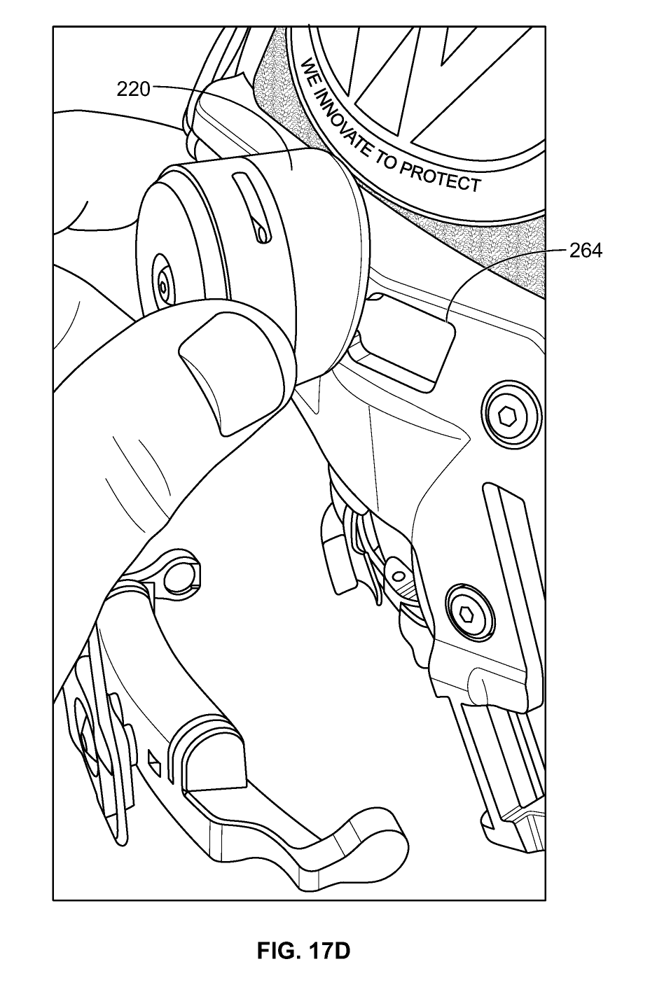

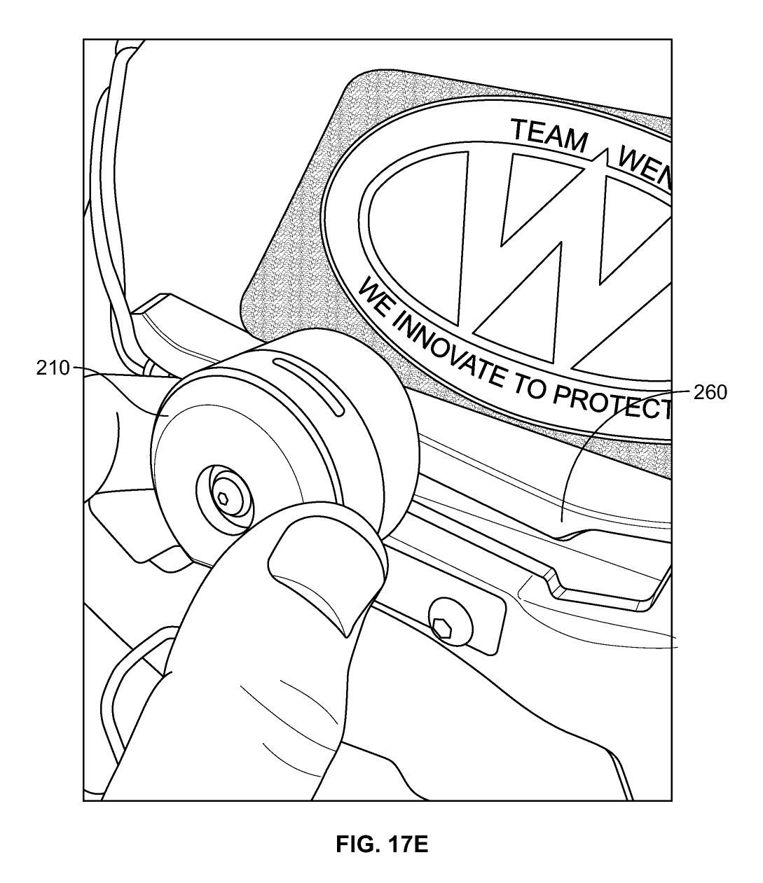

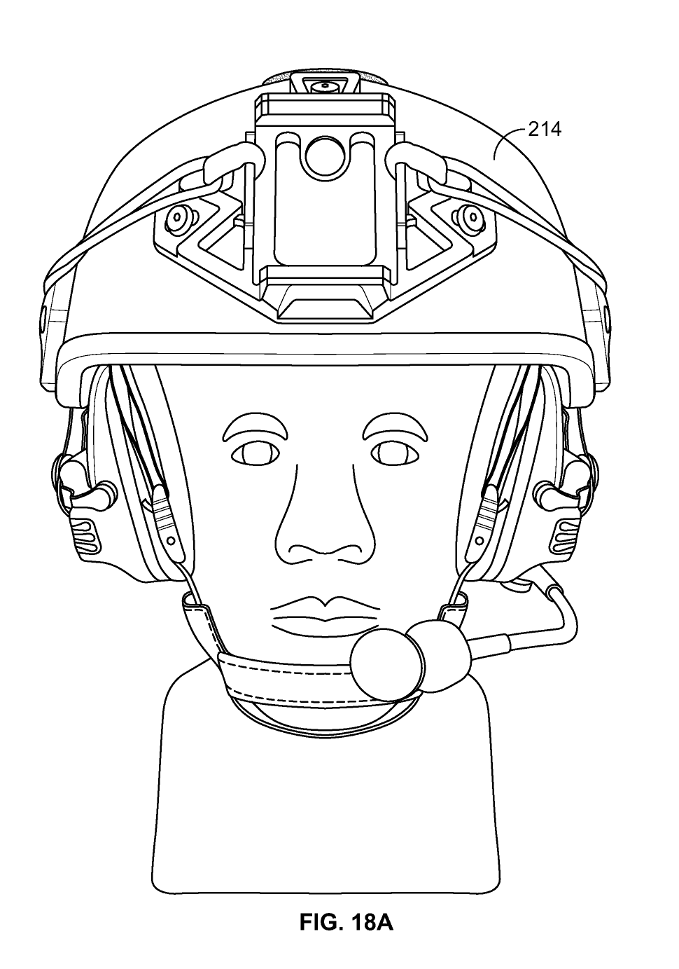

Installation of the headset mount 210 on the helmet 214 is now described with particular reference to FIGS. 17A to 18E. FIG. 17A depicts one of the headset mounts 210 installed on a top rail 260 of the Team Wendy Helmet 214. The top rail includes a longitudinally extending slot or channel 262 with an enlarged opening 264 at its rear end. To install the headset mount 210 onto the top rail 260, the housing 20 is positioned adjacent and behind the enlarged opening 264 of the channel 262. The housing 20 is then moved forward relative to the helmet 214 to pass the leading edge of the T-shaped bracket 232 through the enlarged opening 264 and into engagement with the rear end of the channel 262 (see FIGS. 17B and 17C). The spaces between the base 220 and the inner faces of the cross members 236 defines gaps for the walls of the rail. Put another way, the rail walls adjacent the channel 262 are sandwiched between the base 220 and the cross members 236 of the T-shaped bracket 232. Protrusions 265 extend outwardly from the base and engage against the outer face 263 of the rails system adjacent the channel 262 (see, e.g. FIG. 17B and 17C to further secure the position of the housing relative to the rail system 230. As can be seen with further reference to FIGS. 20C to 20F, the protrusions 265 may be carried by flexible hinges 267 formed on the base 220 that allow the protrusions 265 to flex inwardly (into the base 220) to facilitate installation of the headset mount 210 onto the rail system 230 and to help secure the headset mount in place on the rail system 230. As the headset mount 210 continues to move forward along the channel 262, the arced faces of the cross members 236 bias the T-shaped bracket 232 outwardly from the base 220 (against the force of the springs 250). Similarly the protrusions 267 are flexed inwardly by the pressure exerted outer face 263 of the rail system 230. Once the headset mount 210 reached the desired location on the rail 260, the clamping force exerted by the springs 250, as well as the outward force that the protrusions 265 exert on the face 263, function to releasably retain the headset mount 210 in position on the rail 260. Similarly,

FIGS. 18A and 18B illustrate the headset 138 secured to a helmet 214 by a pair of the headset mounts 210. FIG. 18A illustrates the headset mounts 210 in their operational position, at which the earpieces 94 are lowered in place over the user's ears. FIG. 18B illustrates the headset mounts 210 in their released position, at which the ear pieces are raised away from the user's ears, e.g., to allow the helmet 214 to be removed.

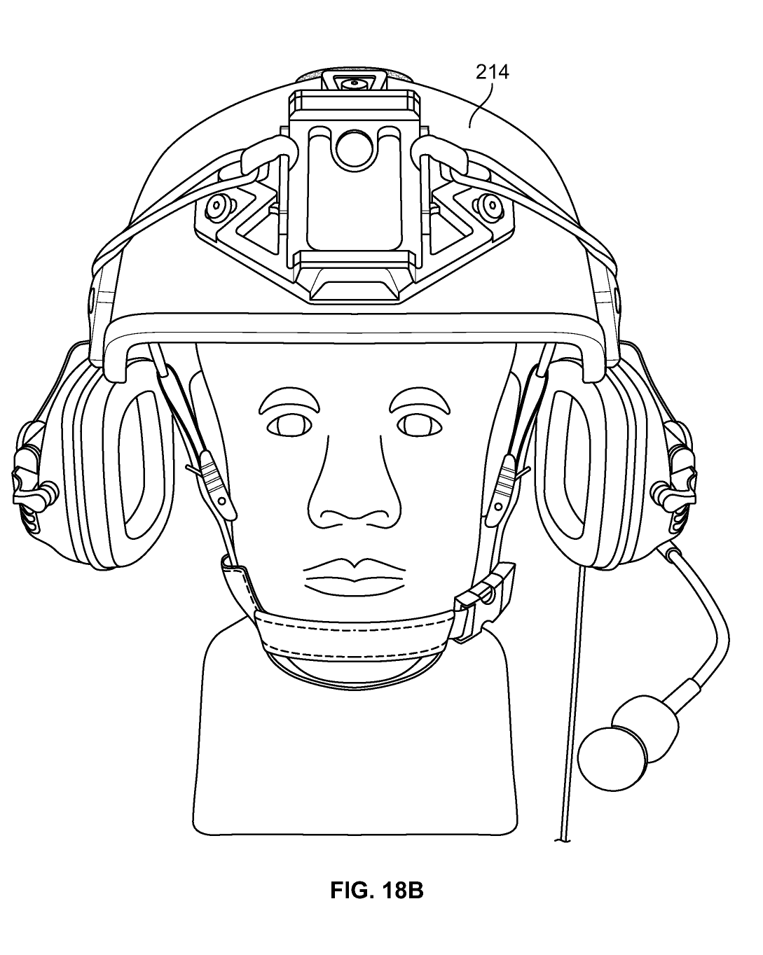

FIG. 19 illustrates the headset mount 210 installed on a back rail 280 of the helmet 224. The headset mount 210 may be installed on the back rail 280 in a manner similar to its installation on the top rail, as described above.

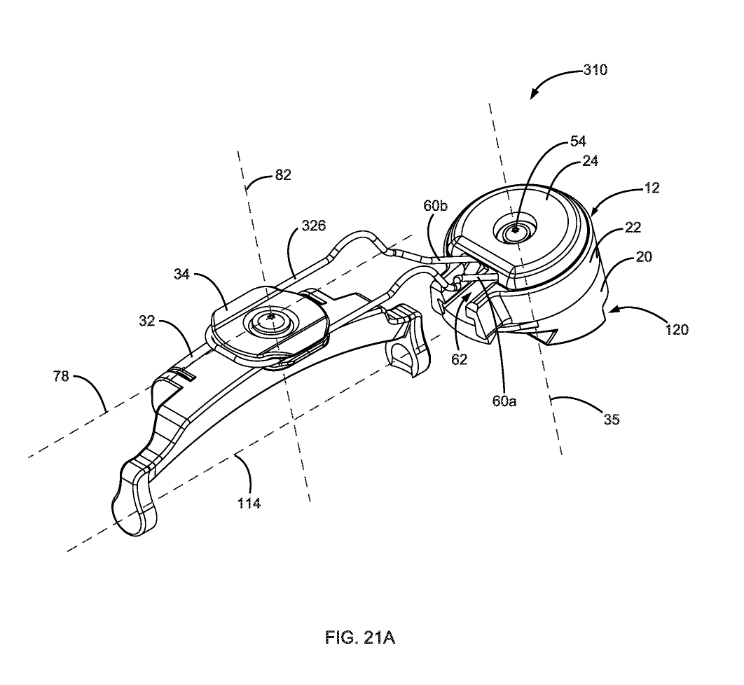

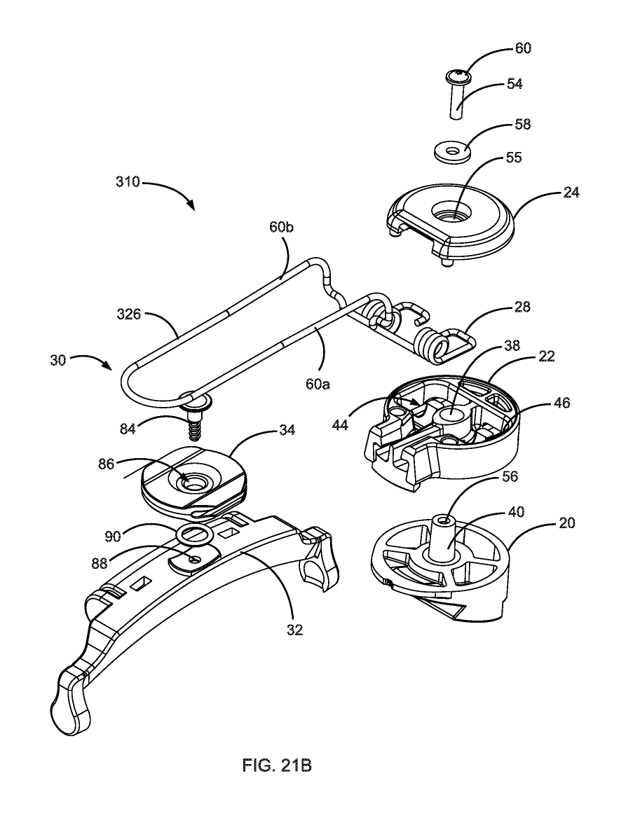

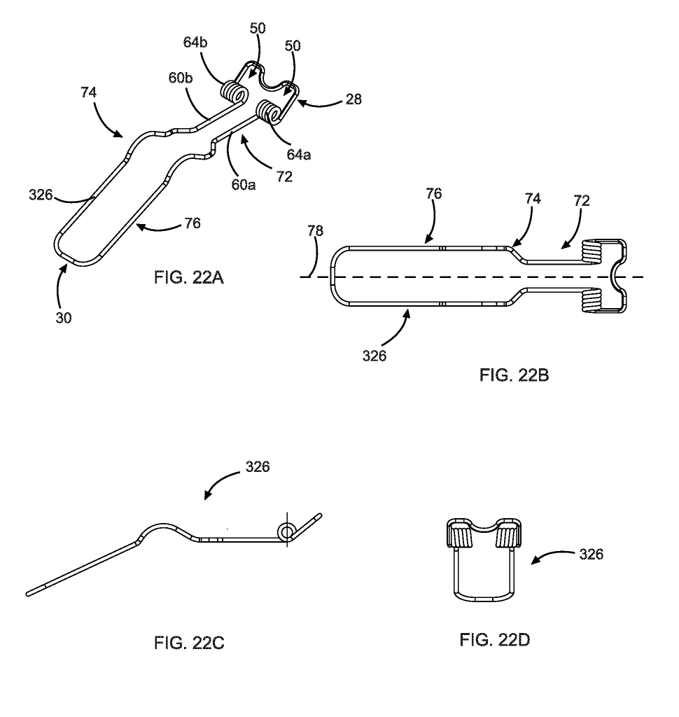

FIGS. 21A and 21B illustrate another embodiment of a headset mount 310 according to certain aspects of the present disclosure. The headset mount 310 includes many of the same components as the headset mount 10 that was described above. Accordingly, the same element numbers have been used to reference like components in the headset mounts 10, 310. The headset mount 310 utilizes a different wireform 326 than the headset mount 10. The wireform 326 is illustrated in greater detail in FIGS. 22A to 22D. The wireform 10 discussed above may be preferably from a manufacturing and use standpoint in at least some applications.

While the present disclosure has been described with reference to certain embodiments, it is to be understood that the above description is intended to be illustrative, and not restrictive. It will be understood by those skilled in the art that various changes may be made and equivalents may be substituted without departing from the scope of the present disclosure. In addition, many modifications may be made to adapt a particular situation or material to the teachings of the present disclosure without departing from its scope. For example, the above-described embodiments (and/or aspects thereof) may be used in combination with each other. In addition, many modifications may be made to adapt a particular situation or material to the teachings of the disclosure without departing from its scope. Any dimensions and types of materials described herein are intended to define the parameters of the disclosure; they are by no means limiting and are exemplary embodiments. Many other embodiments will be apparent to those of skill in the art upon reviewing the above description. Therefore, it is intended that the present disclosure not be limited to the particular embodiment disclosed, but that the present disclosure will include all embodiments falling within the scope of the present disclosure and any appended claims.

What it claimed is:

1. A headset mount for securing an earpiece to a helmet, comprising:
a housing configured to engage with a rail system of the helmet;
a wireform having a first end pivotally connected to the housing for rotational movement relative to the housing about a first axis;
a pivot mount slidably connected to the wireform at a second end of the wireform distal, the pivot mount being movable along a portion of the wireform along a second axis;
a yoke connected to the pivot mount for rotation about a third axis and is connectable to the earpiece such that the earpiece is rotatable about a fourth axis.

2. A headset mount as recited in claim 1, wherein the yoke include a battery socket configured to carry a spare battery.

3. A headset mount as recited in claim 1, wherein the housing includes a feature configured to slidably engage into a channel in the rail system of the helmet.

4. A headset mount as set forth in claim 3, further comprising a detent mechanism configured to releasably lock the helmet mount at any of a plurality of locations along the channel.

5. A headset mount as set forth in claim 4, wherein the detent mechanism comprises at least one protrusion formed on the housing and configured to releasably engage into sockets formed on the rail system adjacent to the channel.

6. A headset mount as set forth in claim 3, wherein the feature comprises a T-shaped bracket that is configured to slidably mate with the channel in the rail system.

7. A headset mount as set forth in claim 6, wherein the T-shaped bracket is configured to compress against a wall of the rail system to releasably lock the headset mount to the rail system.

8. A headset mount as set forth in claim 1, wherein the headset mount is configured to allow the ear piece to be moved between an operational position where the earpiece is lowered and positioned over an ear of a person wearing the helmet and a released position at which the earpiece is raised away from the person's ear.

9. A headset mount as set forth in claim 8, further comprising a locking mechanism for releasably locking the headset mount in the operational position.

10. A headset mount as set forth in claim 9, wherein the locking mechanism comprises an interface between the housing and the wireform.

11. A headset mount as set forth in claim 8, further comprising at least one spring mechanism for normally biasing the assembly to its released position.

12. A headset mount for securing a communications earpiece to a rails system of a helmet, comprising:
a housing including a feature configured to engage into a channel in the rail system of the helmet to permit the housing to be releasably secured to the rail system;
a wireform having a first end pivotally connected to the housing for movement between a first position and a second position;
a pivot mount movably connected to the wireform at a second end of the wireform distal, the pivot mount being longitudinally movable along at least a portion of the wireform;
a yoke connected to the pivot mount for rotational movement relative to the pivot mount, the yoke including a pair of sockets that are configured to receive a mounting balls carried by the earpiece to pivotally secure the earpiece to the socket.

13. A headset mount as recited in claim 12, wherein the yoke include a battery socket configured to carry a spare battery.

14. A headset mount as set forth in claim 12, further comprising a detent mechanism configured to releasably lock the helmet mount at any of a plurality of locations along the channel.

15. A headset mount as set forth in claim 14, wherein the detent mechanism comprises at least one protrusion formed on the housing and configured to releasably engage into sockets formed on the rail system adjacent to the channel.

16. A headset mount as set forth in claim 12, wherein the feature comprises a T-shaped bracket that is configured to slidably mate with the channel in the rail system.

17. A headset mount as set forth in claim 16, wherein the T-shaped bracket is configured to compress against a wall of the rail system to releasably lock the headset mount to the rail system.

18. A headset mount as set forth in claim 12, wherein the headset mount is configured to allow the ear piece to be moved between an operational position where the earpiece is lowered and positioned over an ear of a person wearing the helmet and a released position at which the earpiece is raised away from the person's ear.

19. A headset mount as set forth in claim 18, further comprising a locking mechanism for releasably locking the headset mount in the operational position.

20. A headset mount as set forth in claim 19, wherein the locking mechanism comprises an interface between the housing and the wireform.

21. A headset mount as set forth in claim 18, further comprising at least one spring mechanism for normally biasing the assembly to its released position.
